(19) United States
(12) Patent Application Publication
(10) Pub. No.: US 2026/0279968 A1
(43) Pub. Date: Sep. 17, 2026

(54) CLIMATE CONTROLLED BATTERY MODULE AND METHOD

(71) Applicant: Aspen Aerogels, Inc., Northborough, MA (US)

(72) Inventors: Christopher Stow, Northborough, MA (US); Lixin Wang, Northborough, MA (US); Younggyu Nam, Northborough, MA (US)

(21) Appl. No.: 19/157,002

(22) PCT Filed: Mar. 7, 2024
(86) PCT No.: PCT/US2024/018908

§ 371 Date: Aug. 15, 2025

Related U.S. Application Data
(60) Provisional application No. 63/451,170, filed on Mar. 9, 2023.

(51) Int. Cl. H01M 10/658; H01M 10/0525; H01M 10/613; H01M 10/615; H01M 10/625; H01M 10/647; H01M 10/653; H01M 10/6554; H01M 10/6556; H01M 10/6561; H01M 10/6567; H01M 10/6571; H01M 50/209; H01M 50/249

(52) U.S. Cl. CPC H01M 10/658; H01M 10/0525; H01M 10/613; H01M 10/615; H01M 10/625; H01M 10/647; H01M 10/653; H01M 10/6554; H01M 10/6556; H01M 10/6561; H01M 10/6567; H01M 10/6571; H01M 50/209; H01M 50/249; H01M 2220/20

(57) ABSTRACT

A battery module, and associated methods are disclosed. In one aspect, a thermal management system is included with a stack of battery cells that provides both heating and cooling as needed. Aspects are shown that include heat exchangers with circulating media. Aspects are shown that include resistive elements.

### CLAIM OF PRIORITY

This application is a continuation of and claims the benefit of priority to U.S. Provisional Patent Application Ser. No. 63/451,170, filed on Mar. 9, 2023, which is incorporated by reference herein in its entirety.

### TECHNICAL FIELD

The present disclosure relates generally to materials and systems and methods for preventing or mitigating thermal events, such as thermal runaway issues, in energy storage systems. In particular, the present disclosure provides insulation materials. The present disclosure further relates to a battery module or pack with one or more battery cells that includes the insulation materials, as well as systems including those battery modules or packs. Aspects described generally may include aerogel materials.

### BACKGROUND

Lithium-ion batteries (LIBs) are widely used in powering portable electronic devices such as cell phones, tablets, laptops, power tools and other high-current devices such as electric vehicles because of their high working voltage, low memory effects, and high energy density compared to traditional batteries. However, safety is a concern as LIBs are susceptible to catastrophic failure under “abuse conditions” such as when a rechargeable battery is overcharged (being charged beyond the designed voltage), over-discharged, operated at or exposed to high temperature and high pressure.

To prevent cascading thermal runaway events from occurring, there is a need for effective insulation and heat dissipation strategies to address these and other technical challenges of LIBs.

### BRIEF DESCRIPTION OF THE DRAWINGS

FIG. 1A shows a battery module in accordance with some aspects.

FIG. 1B shows a thermal management system of a battery module in accordance with some aspects.

FIG. 2 shows a battery module housing in accordance with some aspects.

FIG. 3 shows another battery module housing in accordance with some aspects.

FIG. 4 shows another battery module housing in accordance with some aspects.

FIG. 5 shows another battery module housing in accordance with some aspects.

FIG. 6A shows portions of a thermal management system in accordance with some aspects.

FIG. 6B shows other portions of a thermal management system in accordance with some aspects.

FIG. 7 shows a planar structure of a thermal management system in accordance with some aspects.

FIG. 8 shows another planar structure of a thermal management system in accordance with some aspects.

FIG. 9 shows another planar structure of a thermal management system in accordance with some aspects.

FIG. 10 shows a top view of a thermal management system in accordance with some aspects.

FIG. 11 shows a planar structure of a thermal management system in accordance with some aspects.

FIG. 12 shows a method of regulating a battery module in accordance with some aspects.

FIG. 13 shows an electronic device in accordance with some aspects.

FIG. 14 shows an electric vehicle in accordance with some aspects.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Insulation materials, thermal conductor materials, resilient materials, etc. as described in examples below, can be used in battery modules to compartmentalize individual cells, or groups of cells in a battery device. Multiple battery cells that are coupled together are referred to in the present disclosure as battery modules. However, devices and methods described can be used in any of several types of multiple cell arrangements, that may be termed battery packs, battery systems, etc.

### Insulation Material Layers

Insulation materials as described below can be used as a single heat resistant layer, or in combination with other layers that provide additional function to a multilayer configuration, such as mechanical strength, compressibility, heat dissipation/conduction, etc. Insulation layers described herein are responsible for reliably containing and controlling heat flow from heat-generating parts in small spaces and to provide safety and prevention of fire propagation for such products in the fields of electronic, industrial and automotive technologies.

In many embodiments of the present disclosure, the insulation layer functions as a flame/fire deflector layer either by itself or in combination with other materials that enhance performance of containing and controlling heat flow. In one aspect, the insulation layer may itself be resistant to flame and/or hot gases and further include entrained particulate materials that modify or enhance heat containment and control.

One aspect of a highly effective insulation layer includes an aerogel. Aerogels describe a class of material based upon their structure, namely low density, open cell structures, large surface areas (often 900 m²/g or higher) and subnanometer scale pore sizes. The pores may be filled with gases such as air. Aerogels can be distinguished from other porous materials by their physical and structural properties. Although an aerogel material is an exemplary insulation material, the invention is not so limited. Other thermal insulation material layers may also be used in aspects of the present disclosure.

Selected aspects of aerogel formation and properties are described. In several aspects, a precursor material is gelled to form a network of pores that are filled with solvent. The solvent is then extracted, leaving behind a porous matrix. A variety of different aerogel compositions are known, and they may be inorganic, organic and inorganic/organic hybrid. Inorganic aerogels are generally based upon metal alkoxides and include materials such as silica, zirconia, alumina, and other oxides. Organic aerogels include, but are not limited to, urethane aerogels, resorcinol formaldehyde aerogels, and polyimide aerogels.

Inorganic aerogels may be formed from metal oxide or metal alkoxide materials. The metal oxide or metal alkoxide materials may be based on oxides or alkoxides of any metal that can form oxides. Such metals include, but are not limited to silicon, aluminum, titanium, zirconium, hafnium, yttrium, vanadium, cerium, and the like. Inorganic silica aerogels are traditionally made via the hydrolysis and condensation of silica-based alkoxides (such as tetraethoxylsilane), or via gelation of silicic acid or water glass. Other relevant inorganic precursor materials for silica based aerogel synthesis include, but are not limited to metal silicates such as sodium silicate or potassium silicate, alkoxysilanes, partially hydrolyzed alkoxysilanes, tetraethoxylsilane (TEOS), partially hydrolyzed TEOS, condensed polymers of TEOS, tetramethoxylsilane (TMOS), partially hydrolyzed TMOS, condensed polymers of TMOS, tetra-n-propoxysilane, partially hydrolyzed and/or condensed polymers of tetra-n-propoxysilane, polyethylsilicates, partially hydrolyzed polyethysilicates, monomeric alkylalkoxy silanes, bis-trialkoxy alkyl or aryl silanes, polyhedral silsesquioxanes, or combinations thereof.

In certain embodiments of the present disclosure, pre-hydrolyzed TEOS, such as Silbond H-5 (SBH5, Silbond Corp), which is hydrolyzed with a water/silica ratio of about 1.9-2, may be used as commercially available or may be further hydrolyzed prior to incorporation into the gelling process. Partially hydrolyzed TEOS or TMOS, such as polyethysilicate (Silbond 40) or polymethylsilicate may also be used as commercially available or may be further hydrolyzed prior to incorporation into the gelling process.

Inorganic aerogels can also include gel precursors comprising at least one hydrophobic group, such as alkyl metal alkoxides, cycloalkyl metal alkoxides, and aryl metal alkoxides, which can impart or improve certain properties in the gel such as stability and hydrophobicity. Inorganic silica aerogels can specifically include hydrophobic precursors such as alkylsilanes or arylsilanes. Hydrophobic gel precursors may be used as primary precursor materials to form the framework of a gel material. However, hydrophobic gel precursors are more commonly used as co-precursors in combination with simple metal alkoxides in the formation of amalgam aerogels. Hydrophobic inorganic precursor materials for silica based aerogel synthesis include, but are not limited to trimethyl methoxysilane (TMS), dimethyl dimethoxysilane (DMS), methyl trimethoxysilane (MTMS), trimethyl ethoxysilane, dimethyl diethoxysilane (DMDS), methyl triethoxysilane (MTES), ethyl triethoxysilane (ETES), diethyl diethoxysilane, dimethyl diethoxysilane (DMDES), ethyl triethoxysilane, propyl trimethoxysilane, propyl triethoxysilane, phenyl trimethoxysilane, phenyl triethoxysilane (PhTES), hexamethyldisilazane and hexaethyldisilazane, and the like. Any derivatives of any of the above precursors may be used and specifically certain polymeric of other chemical groups may be added or cross-linked to one or more of the above precursors.

Organic aerogels are generally formed from carbon-based polymeric precursors. Such polymeric materials include, but are not limited to resorcinol formaldehydes (RF), polyimide, polyacrylate, polymethyl methacrylate, acrylate oligomers, polyoxyalkylene, polyurethane, polyphenol, polybutadiane, trialkoxysilyl-terminated polydimethylsiloxane, polystyrene, polyacrylonitrile, polyfurfural, melamine-formaldehyde, cresol formaldehyde, phenol-furfural, polyether, polyol, polyisocyanate, polyhydroxybenze, polyvinyl alcohol dialdehyde, polycyanurates, polyacrylamides, various epoxies, agar, agarose, chitosan, and combinations thereof. As one aspect, organic RF aerogels are typically made from the sol-gel polymerization of resorcinol or melamine with formaldehyde under alkaline conditions.

Organic/inorganic hybrid aerogels are mainly comprised of (organically modified silica (“ormosil”) aerogels. These ormosil materials include organic components that are covalently bonded to a silica network.

Ormosils are typically formed through the hydrolysis and condensation of organically modified silanes, R—Si(OX)₃, with traditional alkoxide precursors, Y(OX)₄. In these formulas, X may represent, in one aspect, CH₃, C₂H₅, C₃H₇, C₄H₉; Y may represent, in one aspect, Si, Ti, Zr, or Al; and R may be any organic fragment such as methyl, ethyl, propyl, butyl, isopropyl, methacrylate, acrylate, vinyl, epoxide, and the like. The organic components in ormosil aerogel may also be dispersed throughout or chemically bonded to the silica network.

Aerogels can be formed from flexible gel precursors. Various flexible layers, including flexible fiber-reinforced aerogels, can be readily combined and shaped to give pre-forms that when mechanically compressed along one or more axes, give compressively strong bodies along any of those axes.

One method of aerogel formation includes batch casting. Batch casting includes catalyzing one entire volume of sol to induce gelation simultaneously throughout that volume. Gel-forming techniques include adjusting the pH and/or temperature of a dilute metal oxide sol to a point where gelation occurs. Suitable materials for forming inorganic aerogels include oxides of most of the metals that can form oxides, such as silicon, aluminum, titanium, zirconium, hafnium, yttrium, vanadium, and the like. Particularly preferred are gels formed primarily from alcohol solutions of hydrolyzed silicate esters due to their ready availability and low cost (alcogel). Organic aerogels can also be made from melamine formaldehydes, resorcinol formaldehydes, and the like.

In one aspect, aerogel materials may be monolithic, or continuous throughout a structure or layer. In other aspects, an aerogel material may include a composite aerogel material with aerogel particles that are mixed with a binder. Other additives may be included in a composite aerogel material, including, but not limited to, surfactants that aid in dispersion of aerogel particles within a binder. A composite aerogel slurry may be applied to a supporting plate such as a mesh, felt, web, etc. and then dried to form a composite aerogel structure.

As noted above, an aerogel may be organic, inorganic, or a mixture thereof. In some aspects, the aerogel includes a silica-based aerogel. One or more layers in a thermal barrier may include a reinforcement material.

The reinforcing material may be any material that provides resilience, conformability, or structural stability to the aerogel material. Aspects of reinforcing materials include, but are not limited to, open-cell macroporous framework reinforcement materials, closed-cell macroporous framework reinforcement materials, open-cell membranes, honeycomb reinforcement materials, polymeric reinforcement materials, and fiber reinforcement materials such as discrete fibers, woven materials, non-woven materials, needled non-wovens, battings, webs, mats, and felts.

The reinforcement material can be selected from organic polymer-based fibers, inorganic fibers, carbon-based fibers or a combination thereof. The inorganic fibers are selected from glass fibers, rock fibers, metal fibers, boron fibers, ceramic fibers, basalt fibers, or combination thereof. In some aspects, the reinforcement material can include a reinforcement including a plurality of layers of material.

### Thermal Conductive Layers

In addition to thermal insulating layers, thermally conductive layers may be combined with thermal insulating layers to effectively channel unwanted heat to a desired external location, such as external heat dissipating fins, a heat dissipating housing, or other external structure to dissipate unwanted heat to outside ambient air. In one aspect, a thermally conductive layer or layers helps to dissipate heat away from a localized heat load within a battery module or pack. Aspects of high thermal conductivity materials include carbon fiber, graphite, silicon carbide, metals including but not limited to copper, stainless steel, aluminum, and the like, as well as combinations thereof.

To aid in the distribution and removal of heat by, in at least one embodiment the thermally conductive layer is coupled to a heat sink. It will be appreciated that there are a variety of heat sink types and configurations, as well as different techniques for coupling the heat sink to the thermally conductive layer, and that the present disclosure is not limited to the use of any one type of heat sink/coupling technique. In one aspect, at least one thermally conductive layer of the multilayer materials disclosed herein can be in thermal communication with an element of a cooling system of a battery module or pack, such as a cooling plate or cooling channel of the cooling system. For another aspect, at least one thermally conductive layer can be in thermal communication with other elements of the battery pack, battery module, or battery system that can function as a heat sink, such as the walls of the pack, module or system, or with other ones of the multilayer materials disposed between battery cells.

Thermal communication between the thermally conductive layer and heat sink elements within the battery system can allow for removal of excess heat from the cell or cells adjacent to the multilayer material to the heat sink, thereby reducing the effect, severity, or propagation of a thermal event that may generate excess heat. In addition to removal of heat, a thermally conductive layer can spread, or dissipate heat from a region of high heat concentration to a larger region of lower heat concentration.

### Resilient Material Layers

In addition to thermal insulating layers and thermal conductive layers, one or more resilient material layers may also be included adjacent to the insulating layers to control the temperature of the battery housing. In one aspect, a resilient layer absorbs any volume expansion during the regular operation of one or more battery cells. In one aspect during a charge, the cells may expand, and during a discharge, the cells may shrink. In one aspect, the resilient layer may also absorbs permanent volume expansion caused by any battery cell degradation and/or thermal runaway. Resilient material layers may include, but are not limited to, foam, fiber, fabric, sponge, spring structures, rubber, polymer, etc.

### Configurations

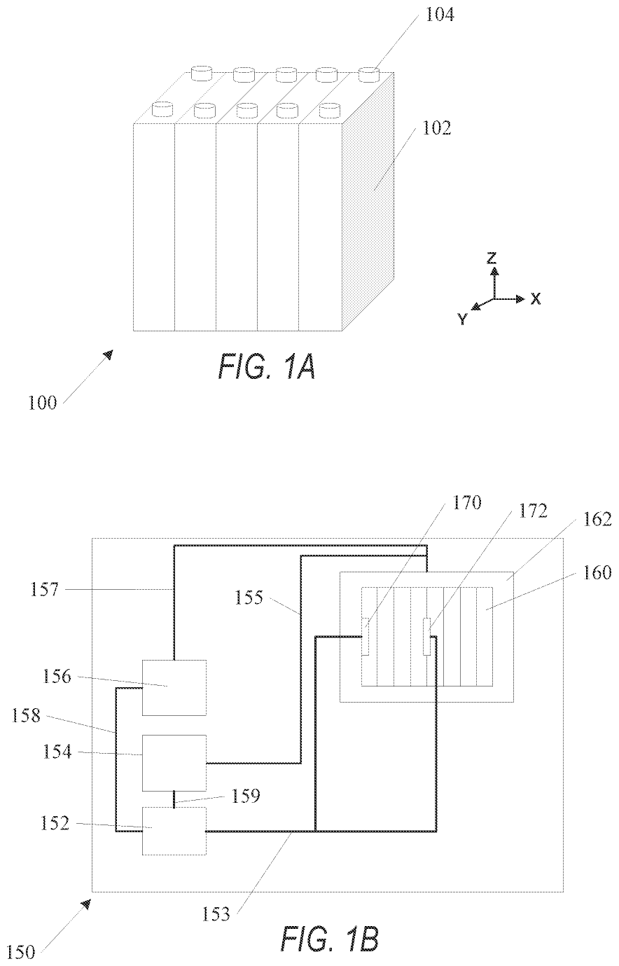

FIG. 1A shows one aspect of a battery module 100. The module 100 includes a stack of battery cells 102. In one aspect, the stack of cells 102 includes lithium ion cells 102. Several configurations of lithium ion cells 102 are possible. In one aspect, the stack of lithium ion cells 102 includes lithium ion prismatic cells or lithium ion pouch cells, although the invention is not so limited. The cells 102 in FIG. 1A each include electrical terminals 104. As noted above, it is desirable to stop or mitigate thermal runaway conditions that can occur in cells such as lithium-ion cells 102.

FIG. 1B shows an aspect of a battery module system. A stack of cells 160, similar to the stack of cells 102 from FIG. 1A. The stack of cells 160 are included in a housing 162. The housing 162 includes a thermal control system as described in a number of aspects of the present disclosure. In the aspect of Figure IB, one or more temperature sensors 170, 172 are shown in thermal communication with the stack of cells 160. A first temperature sensor 170 is located at a periphery of the stack of cells 160, and a second temperature sensor 170 is located between cells internal to the stack of cells 160. Other locations of temperature sensors are also within the scope of the invention.

The temperature sensors 170, 172 are coupled to a control circuit 152 using communication lines 153. In other aspects, communication may be wireless. In the aspect of FIG. 1B, the control circuit 152 is located remote from the stack of cells 160, although the invention is not so limited. In other aspects, the control circuit 152 is located on the stack of cells 160.

A heat system 154 is shown, and a cooling system 156 is shown. The heat system 154 is coupled to the housing 162 by one or more heating conduits 155, and is coupled to the control circuit 152 by circuitry 159.

Similarly, the cooling system 156 is coupled to the housing 162 by one or more cooling conduits 157, and is coupled to the control circuit 152 by circuitry 158. The conduits 155, 157 may include one or more flow pathways for a heat exchanger medium such as a gas or liquid. Hot or cold media may be supplied to heat or cool the stack of cells 160, and a return stream of the hot or cold media may be recirculated back to the respective heat system 154 and/or cooling system 156 after heat transfer in the housing 162. In another aspect, one or more of the conduits 155, 157 may include electrical communication, such as an electrical supply to resistive heating elements or electrical supply to a cooling Peltier device. Electrical power for heating elements or cooling devices may be supplied by the stack of cells in the housing itself, or they may be powered by an external source in alternative aspects.

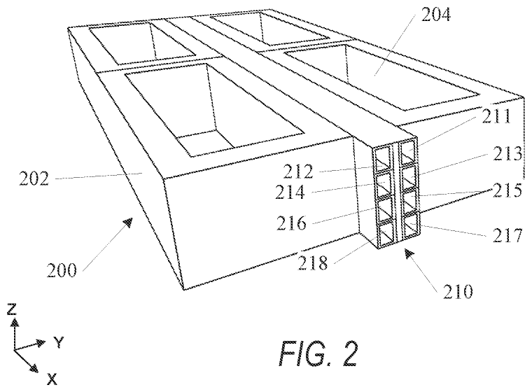

FIG. 2 shows a housing 200 that includes one or more walls 202. The walls 202 form one or more cavities 204 that are adapted to house stacks of battery cells such as battery module 100 from FIG. 1A. A plurality of supply and removal conduits 210 are shown in FIG. 2. In operation, a medium, such as hot air, hot liquid, etc. is passed through one or more walls 202 of the housing 200 to provide heat in the housing 202. In one aspect, the plurality of supply and removal conduits 210 include both a heat supply and removal conduit and a cooling supply and removal conduit. In the aspect of FIG. 2, eight conduits 210 arranged in pairs, with four layers alternatingly stacked on top of each other are shown, although the invention is not so limited. The heat supply and removal conduits and the cooling supply and removal conduits are operated separately. In other words, the heat supply and removal conduits stop working while the cooling supply and removal conduits are in operation, and vice versa.

In one aspect a first pair of conduits 211, 212 may be a first layer pair, with the conduit 211 associated with a heat supply (e.g., heat system 154 in FIG. 1B) and conduit 212 associated with a cooling supply (e.g., cooling system 156 in FIG. 1B). In operation, a medium, such as hot air, hot liquid, etc. is passed through one or more walls 202 of the housing 200 to provide heat to a first layer in the housing 202. In one aspect, the heating medium flows from heat supply 211 to heat removal 212 counterclockwise in X-Y plane when looking along negative Z direction. The heating medium has a higher temperature at heat supply 211 than the heat removal 212 after transferring heat to the battery pack during the travelling inside the walls of the battery pack 202.

Similarly, in one aspect, a second layer pair of conduits 213, 214 may be a first cooling pair, with a cooling supply 213 and a cooling removal 214. In operation, a medium, such as cold air, cold liquid, etc. is passed through one or more walls 202 of the housing 200 to provide cooling to a second layer in the housing 202. The cooling medium flows from cooling supply 213 to a cooling removal 214 counterclockwise in X-Y plane when looking along negative Z direction. The cooling medium has a lower temperature at cooling supply 213 than the cooling removal 214 after absorbing heat from the battery pack during the travelling inside the walls of the battery pack 202.

A third layer pair 215, 216 may include a second heat supply 216 and a second heat removal 215. In one aspect, the heating medium flows from heat supply 216 to heat removal 215 clockwise in X-Y plane when looking along negative Z direction. The heating medium has a higher temperature at heat supply 216 than the heat removal 215. The higher temperature at the heat supply 216 supplements the lower temperature at the first heat removal 212 to mitigate the locational temperature differences due to the loss of heat during the travel of the medium in the battery pack.

A fourth layer pair 217, 218, may include a second cooling pair, with a second cooling supply 218 and a second cooling removal 217. In one aspect, the cooling medium flows from second cooling supply 218 to a second cooling removal 217 clockwise in X-Y plane when looking along negative Z direction. The cooling medium has a lower temperature at second cooling supply 218 than at the second cooling removal 217. The lower temperature at the cooling supply 218 supplements the higher temperature at the cooling removal 214 to mitigate the locational temperature differences due to the absorbing of heat during the travel of the cooling medium in the battery pack.

Although four layers are shown as an example, the invention is not so limited. Fewer than four layers, or more than four layers may also be used. Although alternating layers between heating and cooling are shown, the invention is not so limited. Alternating heating and cooling layers include the advantage of spreading out a heating or cooling effect over a larger surface area of a side of the housing 200. Multiple layer locations more effectively provide a cooling or heating effect to a side, when compared to a single more isolated heating or cooling source on a given side or surface of a battery module.

In one aspect, an internal surface of the number of walls 202 include a thermal conducting material, such as a metal. The internal surface is configured for direct contact with a stack of cells. In one aspect, an external surface of walls 202 includes a thermal insulating material. One aspect of a thermal insulating material includes one or more aerogel configurations described in aspects above, although the invention is not so limited. An external surface of thermal insulating material helps to protect adjacent components of a device such as an electric vehicle that may be located close to a battery module. The thermal insulating material also isolate the battery module from hot or cold environment, therefore increasing the controllability of the battery module. In one aspect, a layer of thermal insulating material is also included to separate layers (e.g., the first, second, third, and fourth layer described above) in the walls 202 of the housing 200. The inclusion of a thermal insulating material between layers helps to provide more precise thermal control by keeping heating layers separate from cooling layers. As noted above, one aspect of a thermal insulating material includes an aerogel.

In one aspect, a control circuit (such as circuit 152 from FIG. 1B) is coupled to a heating unit and a cooling unit. The control circuit is then used to vary an amount of heat provided by the heat supply and removal conduit and to vary an amount of cooling provided by the cooling supply and removal conduit. In one aspect, the control circuit operates with feedback from one or more temperature sensors located adjacent to the battery module.

Battery modules are used in a number of challenging conditions. Providing both heating and cooling to surfaces of a battery module can improve performance over just providing heat, or just providing cooling. In one aspect, heating a battery module to an optimal set temperature can benefit operation in colder conditions such as an electric vehicle operating in winter. In one aspect, heating a battery module to an optimal set temperature can prevent lithium plating during fast charge (e.g., 2C-4C charge) process. Cooling a battery module to an optimal set temperature can benefit operation in warmer conditions such as an electric vehicle operating in summer. Also, cooling a battery module to an optimal set temperature can reduce or eliminate possible thermal runaway conditions. In an alternative to a single set temperature, an acceptable range of operating temperatures can be used, and a heating and cooling system as described can be used to ensure that maximum and minimum temperatures are not exceeded, and that operation of a battery module stays within the acceptable specified temperature range.

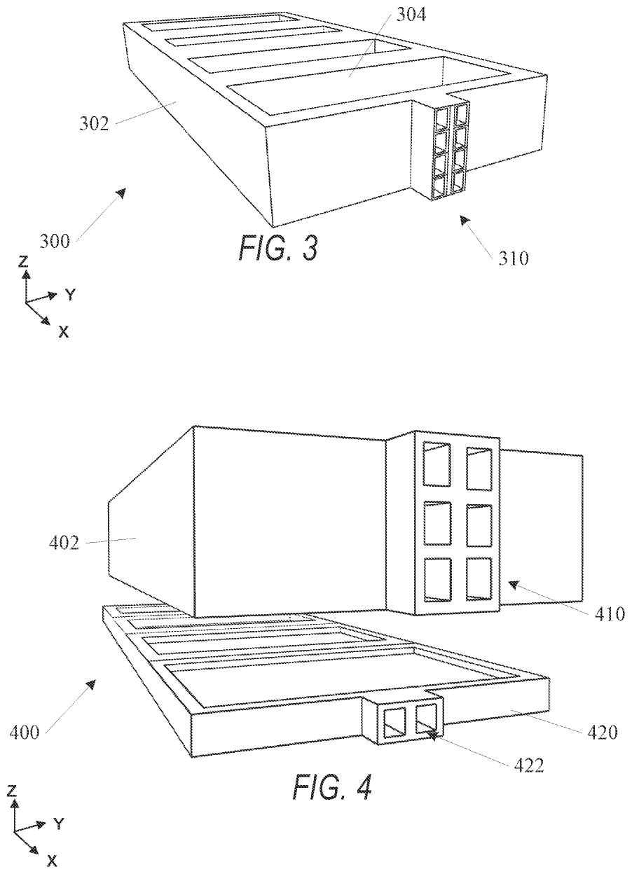

FIG. 3 shows another aspect of a housing 300 that includes one or more walls 302. The walls 302 form one or more cavities 304 that are adapted to house stacks of battery cells such as battery module 100 from FIG. 1A. In FIG. 3, the cavities are arranged into a single row of cavities 304 for enclosing stacks of cells. In contrast, the housing 200 of FIG. 2 is arranged into two rows of cavities 204. By dividing housings 200, 300 into multiple cavities, with different arrangements, improved thermal control is accomplished. More cavities with more walls 202, 302 separating the cavities provides increased ability to control temperature due to more surface area contact on walls of the cavities. In addition, the one row configuration in FIG. 3 provides a simpler cooling or heating medium flow pattern compared to the multiple row configuration in FIG. 2. This simpler flow pattern is easier to manufacturing and maintaining.

A plurality of supply and removal conduits 310 are shown in FIG. 3. Similar to the aspect of FIG. 2, the plurality of supply and removal conduits 310 include both a heat supply and removal conduit and a cooling supply and removal conduit. In the aspect of FIG. 3, eight conduits 310 arranged in pairs, with four layers alternatingly stacked on top of each other are shown, although the invention is not so limited.

FIG. 4 shows another aspect of a housing 400 that includes one or more walls 402 and a bottom structure 420 separated from the one or more walls 402. The walls 402 form one or more cavities 404 that are adapted to house stacks of battery cells such as battery module 100 from FIG. 1A. A plurality of supply and removal conduits 410 are shown in FIG. 4. Similar to the aspect of FIG. 2, the plurality of supply and removal conduits 410 include both a heat supply and removal conduit and a cooling supply and removal conduit. In the aspect of FIG. 4, six conduits 410 arranged in pairs, with three layers stacked on top of each other are shown, although the invention is not so limited.

In FIG. 4, the bottom structure 420 includes a separate plurality of supply and removal conduits 422. In one aspect, the bottom structure 420 includes only cooling. In one aspect, the bottom structure 420 includes only heating. In one aspect, the bottom structure 420 includes both cooling and heating. By including a bottom structure 420 along with side walls 402, a surface area of thermal contact with stacks of cells is increased. The bottom structure 420 also provides additional heating and/or cooling options for the housing 400.

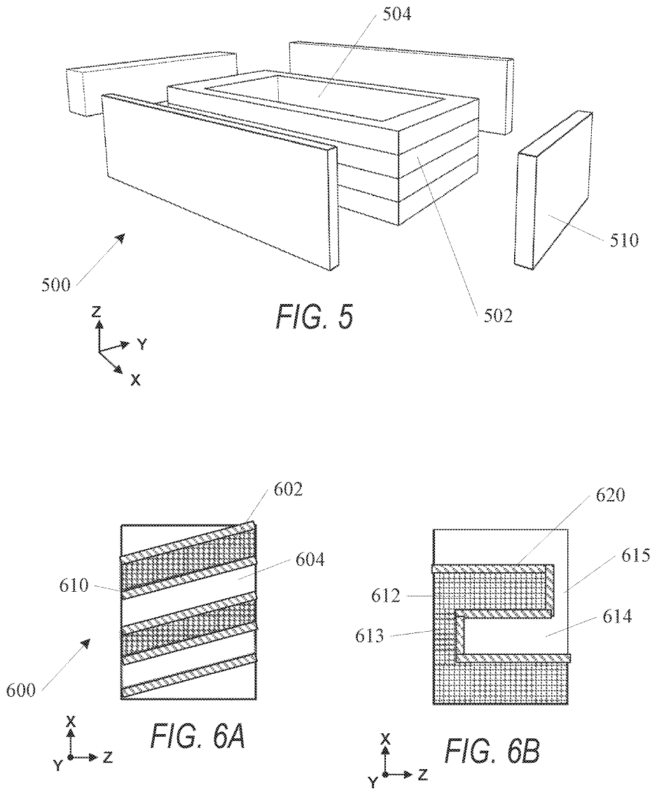

FIG. 5 shows another aspect of a housing 500 that includes one or more walls 502 and a number of insulating panels 510 located around external surfaces of the housing 500. The walls 502 form a cavity 504 that is adapted to house stacks of battery cells such as battery module 100 from FIG. 1A. A plurality of supply and removal conduits similar to aspects above are included, but not shown in FIG. 5. In one aspect the number of insulating panels 510 include aerogel materials, although the invention is not so limited. As in aspects above, an internal surface of the number of walls 502 facing the battery modules may include a thermal conducting material, such as a metal. The number of insulating panels 510 helps to protect adjacent components of a device such as an electric vehicle that may be located close to a battery module. The insulating panels 510 also isolate the battery module from hot or cold environment, therefore increasing the controllability of the battery module and reducing the heat transferring between the battery module and the environment. In one aspect, a layer of thermal insulating material (not shown) is also included to separate layers in the walls 502 of the housing 500. One aspect of a thermal insulating material includes an aerogel.

FIG. 6A shows one aspect of a configuration of heat supply conduits and cooling supply conduits in the walls 600 of the battery housing. In FIG. 6A, a heat supply conduit 602 and a cooling supply conduit 604 are shown. A thermal insulating layer 610 is included in one aspect to separate the heat supply conduit 602 from the cooling supply conduit 604. In the aspect of FIG. 6A, the view is from normal to a major surface of a side of a housing (in X-Z plane). The heat supply conduit 602 and cooling supply conduit 604 are arranged in a descending spiral pattern in the walls 600 that wraps around a stack of cells. In this configuration, a single inlet and outlet can be utilized for each of the heating conduit and the cooling conduit. The configuration of FIG. 6A still allows for multiple windings of heating and cooling to contact a stack of cells, thereby providing well distributed heat transfer from both heating and cooling conduits. The single inlet and outlet configuration simplifies the battery housing for easier manufacturing and maintenance.

FIG. 6B shows another aspect of a configuration of heat supply conduits and cooling supply conduits in a wall 600 of a battery housing. Similar to FIG. 6A, in FIG. 6B, a heat supply conduit 612 and a cooling supply conduit 614 are shown. A thermal insulating layer 620 is included in one aspect to separate the heat supply conduit 612 from the cooling supply conduit 614. In the aspect of FIG. 6B, the view is also from normal to a major surface of a side of a housing (in X-Z plane). The heat supply conduit 612 and cooling supply conduit 614 are alternatingly arranged in parallel layers parallel to the X-Y plane. The colling medium flows vertically (Z-direction) through passage 615 to travel between parallel cooling supply conduit 612 in different layers. The heating medium flows vertically (Z-direction) through passages 613 to travel between parallel heat supply conduit 612 in different layers. In one aspect, the passages 613 and 615 are located at two different vertical edges of the housing. Because the parallel layers are connected to one another by passages 613, 615, a single inlet and outlet can be utilized for each of the heating conduit and the cooling conduit.

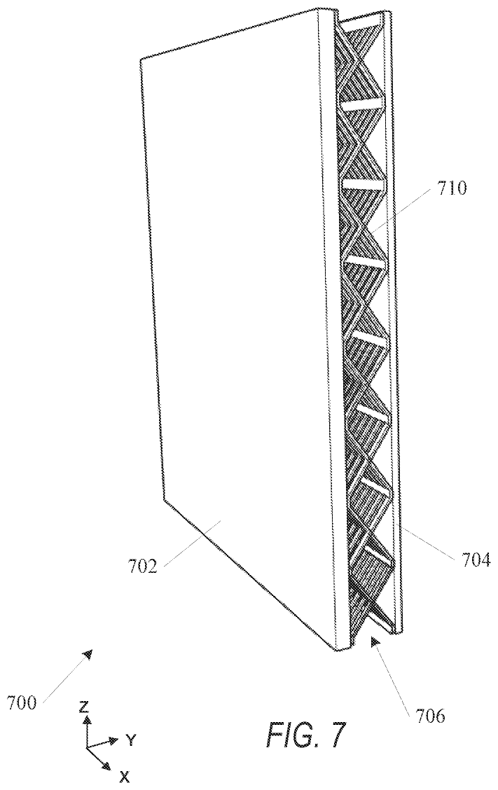

FIG. 7 shows a planar structure 700 that is adapted to function as a heat supply conduit or a cooling supply conduit, similar to the hat supply conduit and the cooling supply conduit described with respect to FIG. 2 to 6B. The planar structure 700 further includes an open structure 710 to mechanically support the conduit and to define the flow pattern of the heat or cold medium.

The planar structure 700 is used as walls of the battery housing similar to the walls 202, 302, 402, 502, and 600 described with respect to FIGS. 2 to 6B. The planar structure 700 can be used adjacent to a wall of a housing, as a wall of a housing (e.g., the walls 202, 302, 402, 502, and 600 described with respect to FIGS. 2 to 6B), in a bottom of a housing, on top of a housing, etc. In one aspect, a wall (e.g., the walls 202, 302, 402, 502, and 600 described with respect to FIGS. 2 to 6B) of the planar structure 700 to be adjacent to a stack of cells includes a thermal conductor material, and a wall of the planar structure 700 to be facing away from a stack of cells includes a thermal insulator material.

The planar structure 700 includes two opposing plates 702, 704 that define a channel 706 therebetween. An open structure 710 is further included within the channel 706. In the aspect of FIG. 7, the open structure 710 includes a number of diagonal cross braces, although the invention is not so limited. The open structure 710 provides mechanical strength to the planar structure 700, and maintains a space between the opposing walls 702, 704.

Because the structure 710 includes open spaces between elements, it is defined as an open structure 710. The spaces allow flow of a heating or cooling medium such as air, other gasses, or liquids. In one aspect, plate 702 faces the external environment of the battery housing. In one aspect, plate 702 is an insulation layer including an insolation material, such as aerogel or aerogel composite. In one aspect, plate 704 faces the battery cells (e.g., battery cells 102 in FIG. 1A) contained in the battery housing. In one aspect, plate 704 is a conductive layer including a conductive material described above, such as metal or graphite.

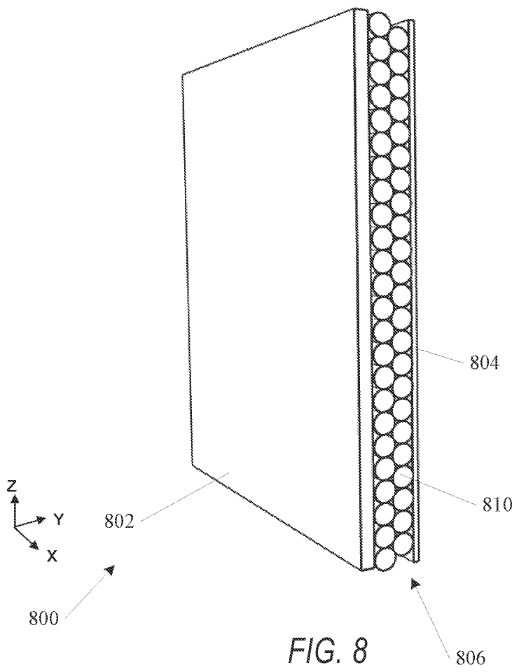

FIG. 8 shows a planar structure 800 that is adapted to function as a heat supply conduit. The planar structure 800 is used as walls of the battery housing similar to the walls 202, 302, 402, 502, and 600 described with respect to FIGS. 2 to 6B. The planar structure 800 can be used adjacent to a wall of a housing, as a wall of a housing (e.g., the walls 202, 302, 402, 502, 600, and 700 described with respect to FIGS. 2 to 7), in a bottom of a housing, on top of a housing, etc. In one aspect, a wall (e.g., the walls 202, 302, 402, 502, 600, and 700 described with respect to FIGS. 2 to 7) of the planar structure 800 to be adjacent to a stack of cells includes a thermal conductor material, and a wall of the planar structure 800 to be facing away from a stack of cells includes a thermal insulator material.

The planar structure 800 includes two opposing plates 802, 804 that define a channel 806 therebetween. In the aspect of FIG. 8, the channel 806 includes a number of heating elements 810, such as resistive heating wires, or quartz elements, etc. Electrical power for heating elements 810 may be supplied by the stack of cells in the housing itself, or they may be powered by an external source in alternative aspects. In one aspect, plate 802 faces the external environment of the battery housing. In one aspect, plate 802 is an insulation layer including an insolation material, such as aerogel or aerogel composite. In one aspect, plate 804 faces the battery cells (e.g., battery cells 102 in FIG. 1A) contained in the battery housing. In one aspect, plate 804 is a conductive layer including a conductive material described above, such as metal or graphite.

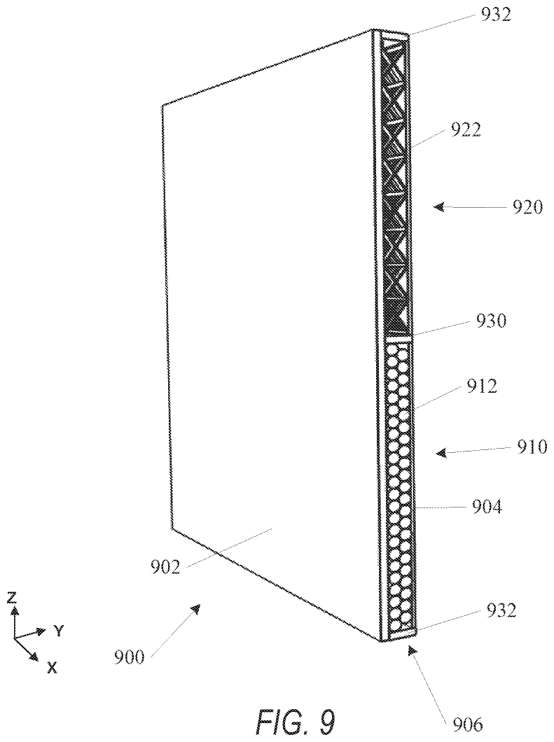

FIG. 9 shows a planar structure 900 that is adapted to function as both a heat supply conduit and a cooling supply conduit. The planar structure 900 is used as walls of the battery housing similar to the walls 202, 302, 402, 502, and 600, 700, and 800 described with respect to FIGS. 2 to 8. The planar structure 900 can be used adjacent to a wall of a housing, as a wall of a housing (e.g., the walls 202, 302, 402, 502, 600, 700, and 800 described with respect to FIGS. 2 to 8), in a bottom of a housing, on top of a housing, etc. In one aspect, a wall (e.g., the walls 202, 302, 402, 502, 600, 700, and 800 described with respect to FIGS. 2 to 8) of the planar structure 900 to be adjacent to a stack of cells includes a thermal conductor material, and a wall of the planar structure 900 to be facing away from a stack of cells includes a thermal insulator material.

The planar structure 900 includes two opposing plates 902, 904 that define a channel 906 therebetween. A heating portion 910 and a cooling portion 920 are shown, defined by the same opposing walls 902, 904. In the heating portion 910, the channel 906 includes a number of resistive heating elements 912, such as wires, or quartz elements, etc. In the cooling portion 920, an open structure 922 is included within the channel 906. In the aspect of FIG. 9, the open structure 922 includes a number of diagonal cross braces, although the invention is not so limited. A first thermal insulating material layer 930 is included to separate the heating portion 910 and the cooling portion 920. In one aspect, the thermal insulating material layer 930 includes an aerogel. A second thermal insulating material layer 932 is included at ends of the planar structure 900. In one aspect, the thermal insulating material layer 932 includes an aerogel.

In one aspect, plate 902 faces the external environment of the battery housing. In one aspect, plate 902 is an insulation layer including an insolation material, such as aerogel or aerogel composite. In one aspect, plate 904 faces the battery cells (e.g., battery cells 102 in FIG. 1A) contained in the battery housing. In one aspect, plate 904 is a conductive layer including a conductive material described above, such as metal or graphite.

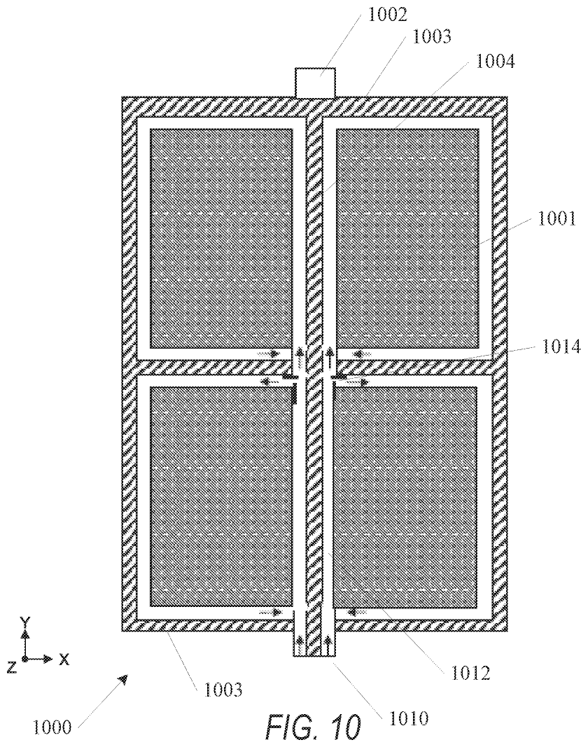

FIG. 10 shows a top view (in X-Y plane view along negative Z direction) of a battery module 1000 according to another aspect. In FIG. 10, a number of stacks of battery cells 1001 (e.g., 4 stacks in FIG. 10) are at least partially enclosed by heating conduits and cooling conduits. FIG. 10 shows a heat coupling 1002 positioned on one housing wall 1003 of the battery module 1000 and a cooling coupling 1010 positioned on another housing wall 1003 of the battery module 1000. In one aspect, housing wall 1002 is opposite to the housing wall 1003 as shown in FIG. 10. The heat coupling 1002 connects to heating conduits 1004 shown in diagonal crosshatch, and the cooling coupling 1010 connects to cooling conduits 1012 shown as white open spaces. Arrows show one possible flow of cooling medium.

In FIG. 10, one or more valves 1014 are included, and can be actuated to direct more or less coolant flow to one of the multiple stacks of battery cells 1001 as needed (in one aspect, as measured by a temperature sensor and directed by a control circuit). In the aspect shown, the heating conduits 1004 include resistive heating elements that can be controlled to one of the multiple stacks of battery cells 1001 as needed (in one aspect, as measured by a temperature sensor and directed by a control circuit).

The aspect of FIG. 10 shows one configuration that incorporates heating conduits 1004 and cooling conduits 1012 concurrently within a housing. During operation, either the heating conduits 1004 or the cooling conduits 1012 are in operation. In one aspect, the one or more valves 1014 are controlled such that only one of the multiple stacks of battery cells 1001 are being cooled by the cooling conduits 1012. Such an operation provides faster coolant flow rate and therefore removes heat more effectively compared to the operation where all stacks of battery cells are cooled. Cooling only one targeted stack of battery cells is especially useful to remove heat from a stack of battery cells under thermal runaway.

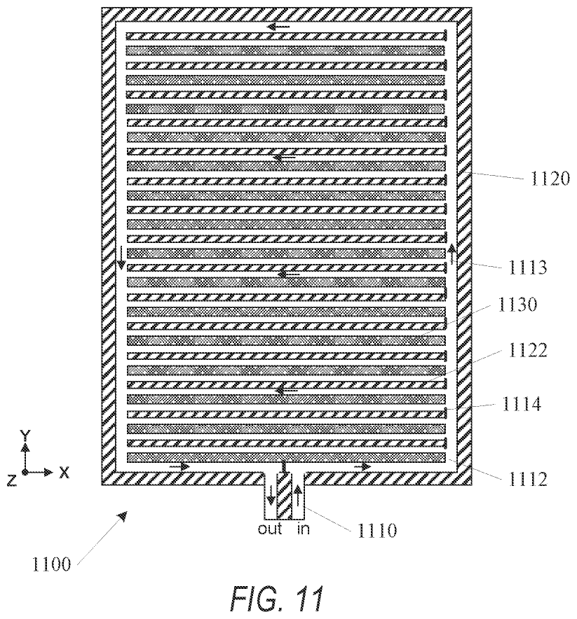

FIG. 11 shows a planar structure 1100 that is adapted to function as a cooling supply conduit. The planar structure 900 is used as walls of the battery housing similar to the walls 202, 302, 402, 502, and 600, 700, and 800 described with respect to FIGS. 2 to 8. The planar structure 900 can be used adjacent to a wall of a housing, as a wall of a housing (e.g., the walls 202, 302, 402, 502, 600, 700, and 800 described with respect to FIGS. 2 to 8), in a bottom of a housing, on top of a housing, etc. In one aspect, a wall (e.g., the walls 202, 302, 402, 502, 600, 700, and 800 described with respect to FIGS. 2 to 8) of the planar structure 900 to be adjacent to a stack of cells includes a thermal conductor material, and a wall of the planar structure 900 to be facing away from a stack of cells includes a thermal insulator material.

As shown in FIG. 11, a cooling coupling 1110 is shown coupled to a number of cooling conduits 1112. Coolant flow is shown with arrows 1113. A perimeter wall 1120 is shown to contain the coolant flow within the cooling conduits 1112. Internal walls 1122 are shown to separate regions of the planar structure 1100 and to define flow over cell regions 1130. The perimeter wall 1120 and the internal walls 1122 are similar to the walls 202, 302, 402, 502, and 600, 700, 800, and 900 described with respect to FIGS. 2 to 9. The perimeter wall 1120 and the internal walls 1122 can be used adjacent to a wall of a housing, as a wall of a housing (e.g., the walls 202, 302, 402, 502, 600, 700, 800, and 900 described with respect to FIGS. 2 to 9), in a bottom of a housing, on top of a housing, etc. In one aspect, a wall (e.g., the walls 202, 302, 402, 502, 600, 700, 800, and 900 described with respect to FIGS. 2 to 9) of the perimeter wall 1120 and the internal walls 1122 are to be adjacent to a stack of cells includes a thermal conductor material, and a wall of the planar structure 900 to be facing away from a stack of cells includes a thermal insulator material.

A number of doors 1114 are included. In one aspect, each internal walls 1122 includes a door 1114 to individually select flow rate over a corresponding cell region 1130. In operation, doors 1114 can be selected to increase flow rate over a middle area of the planar structure 1100 where battery cells tend to operate at higher temperatures. If a thermal runaway condition is detected, doors 1114 can be selected to further provide cooling to a cell or cell region that is overheating. Although cooling is shown in FIG. 11, heating elements can also be incorporated into planar structure 1100 to function as a heating conduit and a cooling conduit. Separate control of heating and cooling can provide better temperature control over a stack of cells. Aspects of planar structure 1100 can be incorporated into sides of a housing, a bottom of a housing, or other locations adjacent to cells in a module.

### Methods

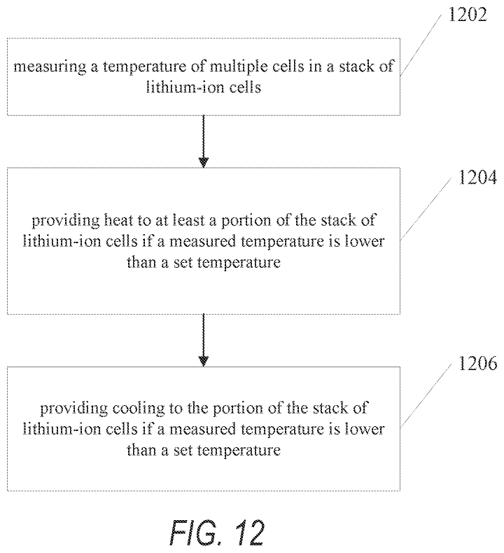

FIG. 12 shows an aspect flow diagram of a method of regulating a battery module. In operation 1202, a temperature of multiple cells is measured in a stack of lithium-ion cells. In operation 1204, heat is provided to at least a portion of the stack of lithium-ion cells if a measured temperature is lower than a set temperature. In operation 1206, cooling is provided to the portion of the stack of lithium-ion cells if a measured temperature is lower than a set temperature,

### Systems

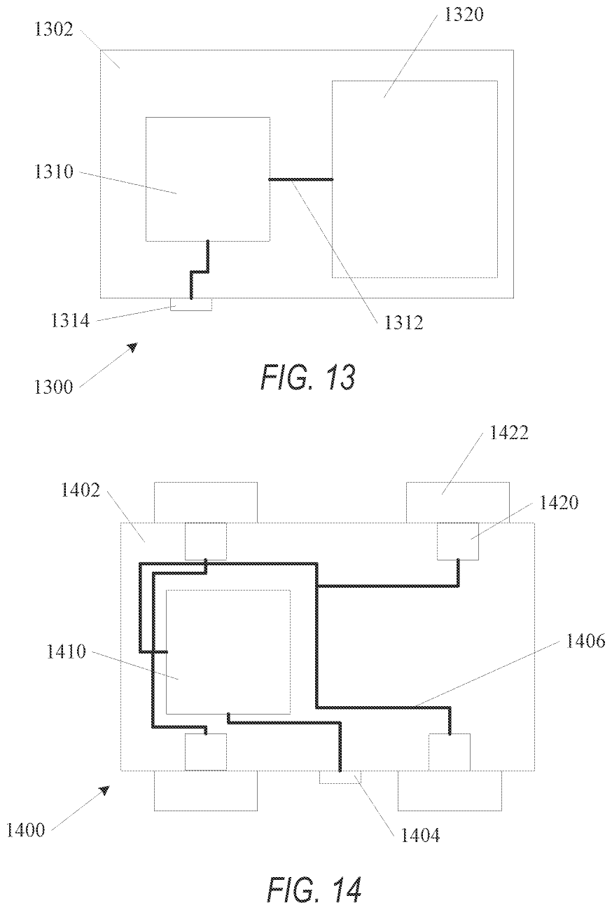

Battery modules as described above are used in a number of electronic devices. FIG. 13 illustrates an aspect electronic device 1300 that includes a battery module 1310. The battery module 1310 is coupled to functional electronics 1320 by circuitry 1312. In the aspect shown, the battery module 1310 and circuitry 1312 are contained in a housing 1302. A charge port 1314 is shown coupled to the battery module 1310 to facilitate recharging of the battery module 1310 when needed.

In one aspect, the functional electronics 1320 include devices such as semiconductor devices with transistors and storage circuits. Aspects include, but are not limited to, telephones, computers, display screens, navigation systems, etc.

FIG. 14 illustrates another electronic system that utilizes battery modules that include thermal management systems as described above. An electric vehicle 1400 is illustrated in FIG. 14. The electric vehicle 1400 includes a chassis 1420 and wheels 1422. In the aspect shown, each wheel 1422 is coupled to a drive motor 1420. A battery module 1410 is shown coupled to the drive motors 1420 by circuitry 1406. A charge port 1404 is shown coupled to the battery module 1410 to facilitate recharging of the battery module 1410 when needed. Aspects of electric vehicle 1400 include, but are not limited to, consumer vehicles such as cars, trucks, etc. Commercial vehicles such as tractors and semi-trucks are also within the scope of the invention. Although a four wheeled vehicle is shown, the invention is not so limited. In one aspect, two wheeled vehicles such as motorcycles and scooters are also within the scope of the invention.

To better illustrate the method and apparatuses disclosed herein, a non-limiting list of embodiments is provided here:
Aspect 1 includes a battery module. The battery module includes one or more lithium-ion cells and a thermal control system in thermal communication with one or more sides of the one or more lithium ion cells. The thermal control system includes at least one of a heating component and a cooling component. The thermal control system also includes a control circuit to vary an amount of cooling or heating provided by the at least one heating component and cooling component.
Aspect 2 includes the battery module of Aspect 1, wherein the at least one of a heating component and a cooling component are located in a surrounding sidewall adjacent to the one or more lithium-ion cells.
Aspect 3 includes the battery module of any one of Aspects 1-2, wherein the thermal control system is included in a planar structure adjacent to the one or more lithium-ion cells.
Aspect 4 includes the battery module of any one of Aspects 1-3, wherein the one or more lithium-ion cells includes a stack of lithium-ion cells.
Aspect 5 includes the battery module of any one of Aspects 1-4, wherein the planar structure is included in a bottom of the stack of lithium-ion cells.
Aspect 6 includes the battery module of any one of Aspects 1-5, wherein the planar structure includes both the heating component and the cooling component.
Aspect 7 includes the battery module of any one of Aspects 1-6, wherein the heating component and the cooling component are separated by an aerogel barrier.
Aspect 8 includes the battery module of any one of Aspects 1-7, wherein the heating component and the cooling component are arranged in horizontal layers of alternating heating component and cooling component.
Aspect 9 includes the battery module of any one of Aspects 1-8, wherein alternating heating components are interconnected, and wherein alternating cooling components are interconnected.
Aspect 10 includes the battery module of any one of Aspects 1-9, wherein the heating components and the cooling components are arranged in spiraling layers along walls of the stack of lithium-ion cells.
Aspect 11 includes an electric vehicle. The electric vehicle includes a vehicle chassis, a plurality of wheels coupled to the vehicle chassis, the plurality of wheels driven by one or more electric motors and a battery module connected to the one or more electric motors. The battery module includes a stack of lithium-ion cells and a thermal control system in thermal communication with one or more sides of the stack of lithium ion cells. The thermal control system includes a heat supply, a cooling circulation system, and a control circuit to vary an amount of heat provided by the heat supply and to vary an amount of cooling provided by the circulation system.
Aspect 12 includes the electric vehicle of aspect 11, wherein the heat supply includes a resistive heat supply.
Aspect 13 includes the electric vehicle of any one of aspects 11-12, wherein the resistive heat supply includes a plurality of resistive heating wire elements.
Aspect 14 includes the electric vehicle of any one of aspects 11-13, wherein the cooling circulation system includes a gas circulation medium.
Aspect 15 includes the electric vehicle of any one of aspects 11-14, wherein the cooling circulation system includes a liquid circulation medium.
Aspect 16 includes the electric vehicle of any one of aspects 11-15, wherein the cooling circulation system includes two opposing walls that define a channel and further including an open structure within the channel.

Aspect 17 includes the electric vehicle of any one of aspects 11-16, wherein the cooling circulation system is included within a bottom structure adjacent to the stack of lithium-ion cells, and wherein the bottom structure also provides structural support for the vehicle chassis.

Aspect 18 includes the electric vehicle of any one of aspects 11-17, wherein the stack of lithium-ion cells includes multiple cell stacks of lithium-ion cells forming zones, and wherein the heat supply and the cooling circulation system are controllable with respect to each of the zones.

Aspect 19 includes the electric vehicle of any one of aspects 11-18, wherein a zone control of the cooling circulation system includes valves.

Aspect 20 includes a method of regulating a battery module. The method includes measuring a temperature of multiple cells in a stack of lithium-ion cells, providing heat to at least a portion of the stack of lithium-ion cells if a measured temperature is lower than a set temperature, and providing cooling to the portion of the stack of lithium-ion cells if a measured temperature is lower than a set temperature.

Aspect 21 includes the method of aspect 20, wherein providing heat to at least a portion of the stack of lithium-ion cells, and providing cooling to the portion of the stack of lithium-ion cells includes providing both heat and cooling to a given side of the stack of lithium-ion cells.

Aspect 22 includes the method of any one of aspects 20-21, wherein providing heat includes providing resistive heating.

Aspect 23 includes the method of any one of aspects 20-22, wherein providing cooling includes circulating a medium through a side of the stack of lithium-ion cells.

The above description is intended to be illustrative, and not restrictive. In one aspect, the above-described aspects (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

Although an overview of the inventive subject matter has been described with reference to specific aspect embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance.

Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the aspect configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims.

The specification and drawings are, accordingly, to be regarded in an illustrative rather than a restrictive sense.

The foregoing description, for the purpose of explanation, has been described with reference to specific aspects. However, the illustrative discussions above are not intended to be exhaustive or to limit the possible aspects to the precise forms disclosed. Many modifications and variations are possible in view of the above teachings. The aspects were chosen and described in order to best explain the principles involved and their practical applications, to thereby enable others skilled in the art to best utilize the various aspects with various modifications as are suited to the particular use contemplated.

It will also be understood that, although the terms “first,” “second,” and so forth may be used herein to describe various elements, these elements should not be limited by these terms. These terms are only used to distinguish one element from another. In one aspect, a first contact could be termed a second contact, and, similarly, a second contact could be termed a first contact, without departing from the scope of the present aspects. The first contact and the second contact are both contacts, but they are not the same contact.

The terminology used in the description of the aspects herein is for the purpose of describing particular aspects only and is not intended to be limiting. As used in the description of the aspects and the appended aspects, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A battery module, comprising:
one or more lithium-ion cells;
a thermal control system in thermal communication with one or more sides of the one or more lithium ion cells, the thermal control system including at least one of:
(i) a heating component;
(ii) a cooling component; and
a control circuit to vary an amount of cooling or heating provided by the at least one heating component and cooling component
wherein the heating component and the cooling component are separated by an aerogel barrier.

2. The battery module of claim 1, wherein the at least one heating component and cooling component are located in a surrounding sidewall adjacent to the one or more lithium-ion cells.

3. The battery module of claim 1, wherein the thermal control system is included in a planar structure adjacent to the one or more lithium-ion cells.

4. The battery module of claim 3, wherein the one or more lithium-ion cells includes a stack of lithium-ion cells.

5. The battery module of claim 4, wherein the planar structure is included in a bottom of the stack of lithium-ion cells.

6. The battery module of claim 3, wherein the planar structure includes both the heating component and the cooling component.

7. (canceled)

8. The battery module of claim 4, wherein the heating component and the cooling component are arranged in horizontal layers of alternating heating components and cooling components.

9. The battery module of claim 8, wherein alternating heating components are interconnected, and wherein alternating cooling components are interconnected.

10. The battery module of claim 4, wherein the heating components and the cooling components are arranged in spiraling layers along walls of the stack of lithium-ion cells.

11. An electric vehicle, comprising:
a vehicle chassis;
a plurality of wheels coupled to the vehicle chassis, the plurality of wheels driven by one or more electric motors;
a battery module connected to the one or more electric motors, the battery module including
a stack of lithium-ion cells;
a thermal control system in thermal communication with one or more sides of the stack of lithium ion cells, the thermal control system including;
a heat supply;
a cooling circulation system; and
a control circuit to vary an amount of heat provided by the heat supply and to vary an amount of cooling provided by the cooling circulation system,
wherein the heat supply and the cooling circulation system are separated by an aerogel barrier.

12. The electric vehicle of claim 11, wherein the heat supply includes a resistive heat supply.

13. The electric vehicle of claim 12, wherein the resistive heat supply includes a plurality of resistive heating wire elements.

14. The electric vehicle of claim 11, wherein the cooling circulation system includes a gas circulation medium.

15. The electric vehicle of claim 11, wherein the cooling circulation system includes a liquid circulation medium.

16. The electric vehicle of claim 11, wherein the cooling circulation system includes two opposing walls that define a channel and further including an open structure within the channel.

17. The electric vehicle of claim 11, wherein the cooling circulation system is included within a bottom structure adjacent to the stack of lithium-ion cells, and wherein the bottom structure also provides structural support for the vehicle chassis.

18. The electric vehicle of claim 11, wherein the stack of lithium-ion cells includes multiple cell stacks of lithium-ion cells forming zones, and wherein the heat supply and the cooling circulation system are controllable with respect to each of the zones.

19. The electric vehicle of claim 18, wherein a zone control of the cooling circulation system includes valves.

20-23. (canceled)
